(19) United States
(12) Patent Application Publication
(10) Pub. No.: US 2011/0232773 A1
(43) Pub. Date: Sep. 29, 2011

(54) DEVICE AND METHOD FOR COMBINING WATER RESERVES

(75) Inventor: Anthony WRIGHT, Queensland (AU)

(73) Assignee: PLASTEC AUSTRALIA PTY LTD, Queensland (AU)

(21) Appl. No.: 13/037,612

(22) Filed: Mar. 1, 2011

Related U.S. Application Data
(63) Continuation-in-part of application No. PCT/AU2009/001122, filed on Aug. 31, 2009.

(30) Foreign Application Priority Data
Sep. 1, 2008 (AU) 2008904525

(51) Int. Cl. A23G 9/28

(52) U.S. Cl. 137/14; 137/602

(57) ABSTRACT

A device for combining water from a first source with a stream of water from a second source which is at a higher pressure than said one source is disclosed. The device includes a hollow body having a primary inlet for operative coupling to said second source of water and an outlet towards an opposed end thereof. The body also has an intermediate inlet positioned intermediate said primary inlet and outlet for coupling to said first source of water. The device further includes a venturi positioned intermediate said intermediate inlet and said outlet, and a flow restriction means that is a jet positioned upstream of said venturi for restricting the flow of water issuing therefrom. The jet is substantially longitudinally aligned with said intermediate inlet. In use water from said second source enters said body through said primary inlet and passes through said jet. This draws water from said first source of water through said intermediate inlet and into the body. The combined stream of water passes through said venturi and through the outlet.

### CROSS-REFERENCE TO RELATED APPLICATIONS

This application is a continuation-in-part of the International Application No. PCT/AU2009/001122 filed Aug. 31, 2009, which claims the benefit of Australian Application No. AU2008904525 filed Sep. 1, 2008, which are incorporated herein in their entireties

### FIELD OF THE INVENTION

This invention relates to an apparatus for combining water from one water reserve or water source with a stream of water from another water reserve or water source. This invention also extends to a method of combining water from one water reserve or water source with a stream of water from another water reserve or water source.

This invention relates particularly but not exclusively to a method of combining water from one water reserve or water source that is a water tank with a stream of water from another water reserve or water source that is a mains water supply to yield a combined stream of water that contains both tank water and domestic mains water.

### BACKGROUND TO THE INVENTION

Water for city-, town- or other relatively highly populated- suburban communities is generally provided by means of large scale reticulation systems where water is collected in dams and distributed to users. For more rural communities, users themselves provide for independent water collection by means of water tanks which store water that has been collected off roofs or other water collection surfaces.

With decreasing rainfall being experienced in some catchment areas where Government-owned dams are sited, greater attention is now being given to collecting and storing rainwater on the afore-mentioned suburban properties to reduce reliance on reticulated water supplies.

Of course, water tanks to store rainwater from run-off from the roofs of houses, garages and the like are well known. Larger tanks are usually cylindrical in shape and manufactured from plastic, steel or concrete. These larger tanks, because of their size and shape, usually require some form of bedding of sand, crusher dust or concrete for support and occupy significant ground area.

Where ground area is at a premium, an alternative tank configuration, usually rectangular in shape, can be chosen. Such a tank can be positioned against the wall of a building under the roof eaves. These smaller tanks are usually supported on a raised platform.

The physical size of the larger tanks often preclude their use on a suburban property and, if the smaller-type tank is used, only a relatively low volume of rainwater can be collected and stored at any given time.

In some instances where a rainwater collecting tank is installed on a property serviced by a reticulated water supply, the subsequent use of that rainwater is by a system independent of the reticulated water supply. Accordingly the user has to make a conscious decision to select rainwater from the tank in preference to the reticulated water. The ease of use of a reticulated supply usually means that the rainwater is not always utilized when it is available. Once the rainwater tank is full subsequent rain cannot be collected and is thus wasted until such time as the user depletes the quantity of rainwater already stored. Also, if the rainwater in a tank is not used for a period of time, it may stagnate and be rendered unsafe for future domestic use.

A prior art attempt to provide this advantage is the RAINBANK® Automatic Rainwater Harvest controller manufactured by Davey Water Products Pty Ltd. This controller is an electrically powered pump plumbed into the pipes that provide reticulated water for toilet and laundry applications. When, for example, a washing machine is activated or a toilet is flushed, the system detects this demand and automatically checks to see if there is sufficient water in the rainwater storage tank. If there is sufficient rainwater, the system switches to this source, completes the demand cycle and then switches off.

However, there are a number of disadvantages of such a system which include:
such a pump is relatively expensive to manufacture and purchase;
the pump is electrically operated and is thus increasing the power consumption of the property on which it is operating when the focus in today's society is to reduce energy consumption and any savings in the use of reticulated water may be offset by this increased energy consumption;
an electrically operated pump is noisy in operation which can be annoying to neighbours in a highly populated suburban area;
detection of available rainwater in a tank is usually by a float switch which requires a certain level of water present to activate that switch and the ever-presence of this required minimum level reduces the capacity to collect further rainwater;
an electrically operated pump requires regular and usually specialized maintenance and repairs thus leading to increased costs to the user of such a pump.

In the event of an electrical power cut, the afore-mentioned RAINBANK® pump automatically limits water to the reticulated water supply. As a power cut often occurs during rain storms and the like, if the rainwater tank happened to be full at the time of the power cut, there is a potential for additional rainwater to go to waste rather than be collected for use later. Further, some users are concerned at the use of “untreated” rainwater for household purposes such as the laundry, as well as the shower, bath or kitchen sink (where drinking water is often sourced). Thus they do not wish for tank water to be mixed with the primary incoming reticulated water supply for use for all household purposes. While it is possible to limit the use of tank water to a particular requirement such as solely flushing of the toilet, for example, by plumbing separate prior art devices at the required locations, this is Inconvenient and clearly adds to the aforementioned disadvantage of Increasing expense.

In this regard, the present inventor was aware that a non-powered device such as a venturi could be used In an arrangement to mix reticulated water with a second source of non-pressurized water. One example is an aqueous fertilizer solution which is held in a container secured at or near the end of a garden hose which, when reticulated water is flowing through the hose, results in the fertilizer solution being drawn up through the venturi to mix with the reticulated water as it is sprayed onto a lawn, flower bed or the like. However, to those skilled in the art, it was considered that a venturi can only operate in such an environment because the reticulated water pressure downstream of, but very close to, the venturi drops essentially to ambient pressure. At higher pressures, the “back” pressure along the hose would be too great such that there is insufficient differential for the venturi to operate and draw water from the second source and, therefore, such a venturi could not be used in the environment to which this invention relates.

It would be advantageous if improved methods and contrivances for utilizing stored tank water obtained by collecting rain water could be devised.

### SUMMARY OF THE INVENTION

The instant inventor has surprisingly discovered that a certain construction which may include a venturi can operate in any required reticulated water pressure environment irrespective of the relative location of that venturi to the eventual exit of that reticulated water.

According to one aspect of the present invention, there is provided a device for combining fluid held in a first source at a first pressure with flowing fluid from a second source flowing at greater than said first pressure; said device including:
a hollow body adapted to be connected at one end to incoming said second source of fluid, its other end being adapted to subsequently distribute said incoming fluid for its required use after passing through said body; and
a pressure differential means within said hollow body;
wherein, said pressure differential means includes (a) a first restriction means through which said flowing fluid first passes, and (b) a second restriction means through which said flowing fluid issuing from said first restriction means passes, such that any fluid held in said first source is drawn into said hollow body to combine with said incoming fluid from said second source and to exit at said other end of said hollow body.

The turbulence of said flowing fluid may be substantially reduced as it passes through said second restriction means.

The device may further include a communication conduit for connecting said hollow body to said first source of fluid for allowing water in said first source to pass into said hollow body.

The hollow body and the first restrictor therein may provide a substantially laminar flow of flowing fluid from the second source as it passes through said second restriction means. That is the flow of fluid from the second source issuing from the first restriction means and passing into the second restriction means may be narrow and focused and confined.

Preferably, said first restriction means is a jet.

Said first restriction means may be adjustable positionally within said hollow body.

Said first restriction means may be removable, e.g. reversibly removable, from said hollow body.

Preferably said second restriction means is a venturi.

Said second restriction means may be adjustable positionally within said hollow body.

Said second restriction means may be removable, e.g. reversibly removable from said hollow body.

Further said first restriction means and said second restriction means may be capable of independent adjustment of their positions within said hollow body.

Preferably, each of said fluid is a liquid.

Preferably, said liquid is water.

Said hollow body and said communication means may be an integral unit, e.g. in the form of a T-body.

Instead said hollow body and said communication means may be reversibly or releasably connected together.

Said device may include a non-return valve for preventing fluid from said second source passing in a reverse direction through the communication means and into the first source, e.g. a storage means, for said fluid held in said first source.

According to a yet further aspect of the present invention, there is provided a method to combine fluid held in a first source at a first pressure with flowing fluid from a second source flowing at greater than said first pressure, wherein a device as defined in the preceding aspect of the invention is fitted between an outlet of said second source of fluid and an outlet of said first source of fluid.

The device may include any one or more of the optional or preferred features of the device defined above in the preceding aspect of the invention.

According to another aspect of this invention there is provided a device for combining water from a first source with a stream of water from a second source which is at a higher pressure than said one source, including:
a hollow body having a primary inlet for operative coupling to said second source of water and an outlet, and an intermediate inlet positioned intermediate said inlet and outlet for coupling to said first source of water,
a venturi on said hollow body positioned intermediate said intermediate inlet and said outlet, and
a flow restriction means on said hollow body positioned upstream of said venturi and communicating with said primary inlet,
wherein water from said second source enters said body through said primary inlet and passes through said flow restriction means and draws water from said first source of water through said intermediate inlet and into the body where it combines with water from the second water source and wherein the combined stream of water from said first and second sources is discharged through said outlet.

The flow restriction means may be a jet.

The jet may have a jet nozzle and the jet nozzle may be configured to produce substantially laminar flow of water downstream of said jet.

The jet may be positioned such that it is substantially longitudinally aligned with said intermediate inlet.

The hollow body may comprise a support body component, a flow restrictor body component and a venturi body component.

The flow restrictor body component may be releasably mounted on the support body component, and the venturi body component may be releasably mounted on the support body component.

The longitudinal position of the jet within the hollow body may be adjustable to enable an operator to optimise operation of the device. Adjusting the longitudinal position of the jet will alter the draw of water from the second source through the intermediate inlet. The position can be adjusted until the optimum operation is obtained. In particular the longitudinal position of the jet within the hollow body may be adjusted by adjusting the longitudinal position of the restrictor body component relative to the support body component.

The longitudinal position of the venturi within the body may also be adjustable to enable an operator to optimise operation of the device. As with the jet adjusting the longitudinal position of the jet will alter the draw of water though the intermediate inlet. In particular the longitudinal position of the venturi within the hollow body may be adjusted by adjusting the longitudinal position of the venturi body component relative to the support body component.

That is the flow of fluid from the second source issuing from the jet and passing into the venturi may be narrow and focussed and confined.

The support body component may be a T-body, and the primary inlet and the outlet may be formed in one member of the T-body, and the intermediate inlet may be formed by the other member of the T-body.

The T-body may have a substantially circular cross sectional shape and each of said one and other members of the hollow body may have a cylindrical configuration. The flow restrictor body component and the venturi body component may each have a circular cross sectional configuration along a substantial portion of its length.

The device may further including a conventional non-return valve for resisting the flow of water in a reverse direction through said intermediate inlet. The non-return valve may be mounted on said other member of the T-body inline with the intermediate inlet in a manner well known to those skilled in the art.

The invention also extends to a plumbing assembly including a device as defined above in the first aspect of the invention.

The plumbing assembly may further include one inlet conduit coupling the primary inlet to the second source, e.g. a reticulated supply and another inlet conduit coupling the intermediate inlet to the second source, e.g. a water tank containing collected rain water. The plumbing assembly may further include an outlet conduit coupled to the outlet and extending down stream therefrom.

The plumbing assembly may further include a non-return valve coupled inseries with the intermediate inlet for resisting water from said second supply from flowing into and through said other inlet conduit. The plumbing assembly may further include a water tank coupled to said other inlet conduit.

The device may include any one or more of the optional or preferred features of the device defined above in the preceding aspect of the invention.

According to yet another aspect of this invention there is provided a method for combining water from one water source with a stream of water from another water source at a higher pressure than said one source, including:
providing a device including a hollow body having a primary inlet towards one end thereof for operative coupling to said second source of water and an outlet towards an opposed end thereof, and an intermediate inlet positioned intermediate said inlet and outlet ends for coupling to said first source of water, a venturi positioned intermediate said intermediate inlet and said outlet, and a flow restriction means positioned upstream of said venturi,
directing water from said second source through said primary inlet and through said flow restriction means whereby to draw water at a lower pressure from said first source of water through said intermediate inlet where it combines with water from the second water source to form a combined water stream which is drawn through the venturi and then discharged through the outlet.

The device may include any one or more of the optional or preferred features of the device defined above in any of the preceding aspects of the invention.

This invention thus enables a property serviced by a reticulated water supply and a rainwater holding tank to utilize available rainwater automatically when it accesses the reticulated supply because the tank water is drawn into the stream of water formed by the reticulated supply by the flow of the reticulated supply alone and is combined therewith prior to use.

Thus this invention relates to the more efficient use of available water reserves, in particular, it finds especial, but not limiting, use as a device and its method of use which allows any tank collected rainwater to be utilised automatically with a reticulated water supply. This invention enables rain water which is collected in a tank, e.g. at a domestic dwelling, to be combined with a stream of water from a domestic mains water supply by combining it with the mains water at a single point and the combined stream can then used for domestic water usage. This way the tank water augments the domestic mains water and facilitates a reduction in the amount of domestic mains water that is used to provide water for water fixtures within a domestic dwelling or the like. Further the use of the tank water is seamless as the tank water is automatically drawn from the tank and combined with the mains water stream without any action being required by a user.

### BRIEF DESCRIPTION OF THE DRAWINGS

In the drawings:

FIG. 1 is a schematic perspective view of a device for combining water reserves constructed in accordance with one embodiment of the present invention;

FIG. 2 is a schematic perspective cross-sectional view of the device of FIG. 1, with the section taken along the longitudinal axis A-A; and

FIG. 3 is a schematic cross-sectional view of the device of FIGS. 1 & 2 identifying the dimensions (mm) of the various features of the example embodiment of the device used in this description.

### DETAILED DESCRIPTION OF THE INVENTION

A method and apparatus for combining water reserves in accordance with this invention may manifest itself in a variety of forms. It will be convenient to hereinafter describe one embodiment of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description.

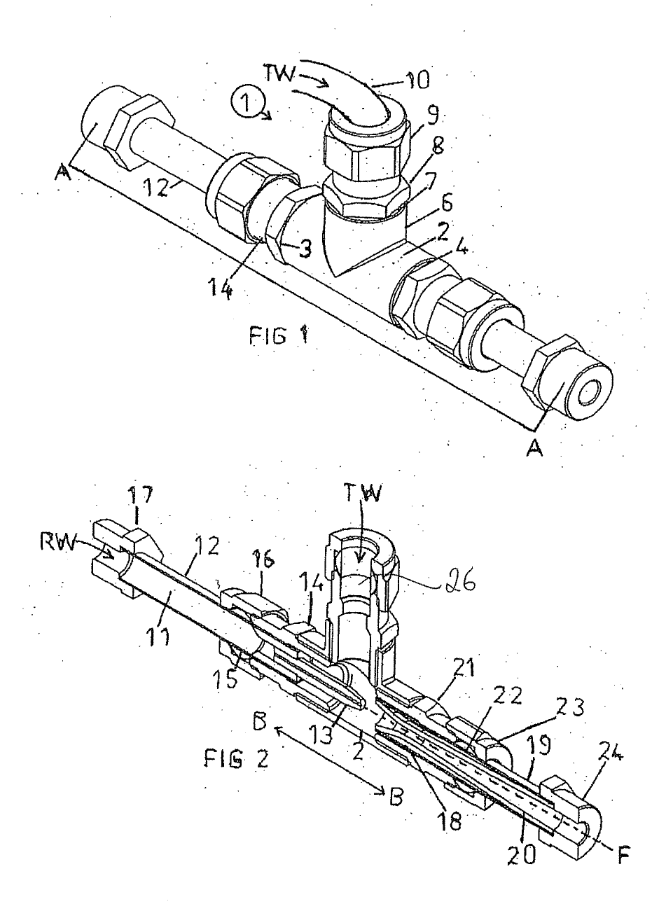

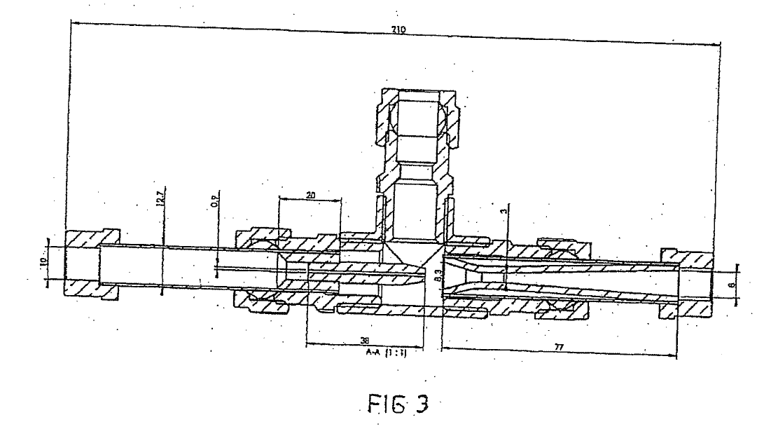

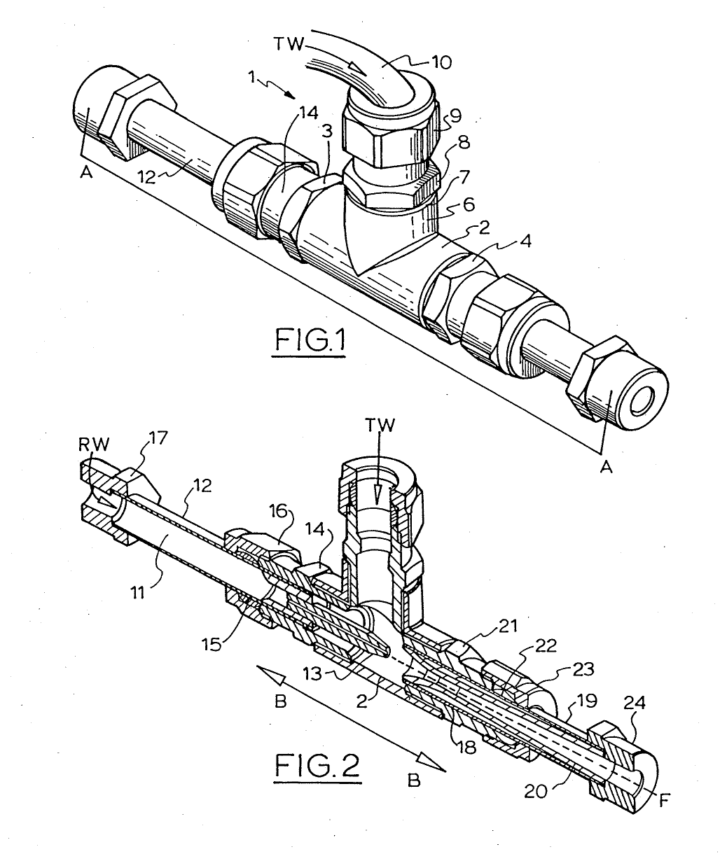

FIGS. 1 to 3 show a device for combining water reserves that is indicated generally by the reference numeral 1.

The device includes a hollow body having a primary inlet for operative coupling to said second source of water and an outlet, and an intermediate inlet positioned intermediate said inlet and outlet for coupling to said first source of water. The device also includes a venturi on said hollow body positioned intermediate said intermediate inlet and said outlet. Yet further the device includes a flow restriction means that is a jet on said hollow body positioned upstream of said venturi. Water from said second source enters said body through said primary inlet and passes through said flow restriction means and draws water from said first source of water through said intermediate inlet and into the body. Inside the body water from the first water source combines with water from the second water source and then the combined stream of water from said first and second sources is discharged through said outlet.

The jet has a jet nozzle that is configured to produce a narrow and confined stream of water issuing from the jet downstream of said jet. As is shown in the drawings the jet is positioned such that it is substantially longitudinally aligned with said intermediate inlet.

Referring to FIGS. 1-3, an illustrated embodiment of a device in accordance with this invention is illustrated at 1. This device (1) comprises a hollow substantially T- shaped body (2), having a first threaded Inlet (3) and a first threaded outlet (4). The integral hollow leg (6) of the T-body (2) terminates with a second threaded inlet (7).

By the use of any suitably complementary threaded adaptor (8) and locking connector (9) well known in the art, a hose or pipe (10) leading from a source TW of tank water can be connected to the inlet (7).

The internal bore (11) of a hollow cylindrical body (12) is threaded at one end to which a complementary threaded jet (13) is removably attached. By the use of any suitable adaptor (14), olive (15) and locking connector (16) well known in the art, the body (12) can be connected to the inlet (3). Similarly, by the use of any suitable adaptor(s) (17) well known in the art, the other end of the body (12) can be plumbed in to a source of reticulated water RW. The dimensions of the components (2, 12, 14, 15, 16) are such that the position of the body (12) can be varied along the longitudinal axis B-B before locking down, thus varying the position of the Jet (13) within the body (2). Further, construction is such that the reticulated water RW is restricted to pass through first the body (12) and then the jet (13).

The internal bore (18) of a hollow cylindrical body (19) incorporates a venturi (20). By the use of any suitable adaptor (21), olive (22) and locking connector (23) well known in the art, the body (19) can be connected to the outlet (4). Similarly, by the use of any suitable adaptor(s) (24) well known in the art the other end of the body (19) can be plumbed back in to the piping associated with the source of reticulated water. The dimensions of the components (2, 19, 24) are such that the position of the body (19) can be varied along the longitudinal axis B-B before locking down, thus varying the position of the venturi (20) within the body (2). Further, construction is such that the reticulated water RW, and any tank water TW within the body (2), is restricted to pass through the venturi (20) when the device (1) is in operation.

In the illustrated embodiment the body 1 and the pipe 10 extending to the water tank are releasably coupled to each other. Further the hollow leg 6 of the T-shaped body 2 includes a non-return valve therein which resists water from the reticulated water supply from flowing in a reverse direction through the pipe 10. The non-return valve is indicated schematically in FIG. 2 by reference numeral 26. Such a non-return valve 26 is well known in the art and as such does not require further explanation in this description.

The various components of the device (1) can be manufactured from any suitable materials known in the art, including metal and plastics materials.

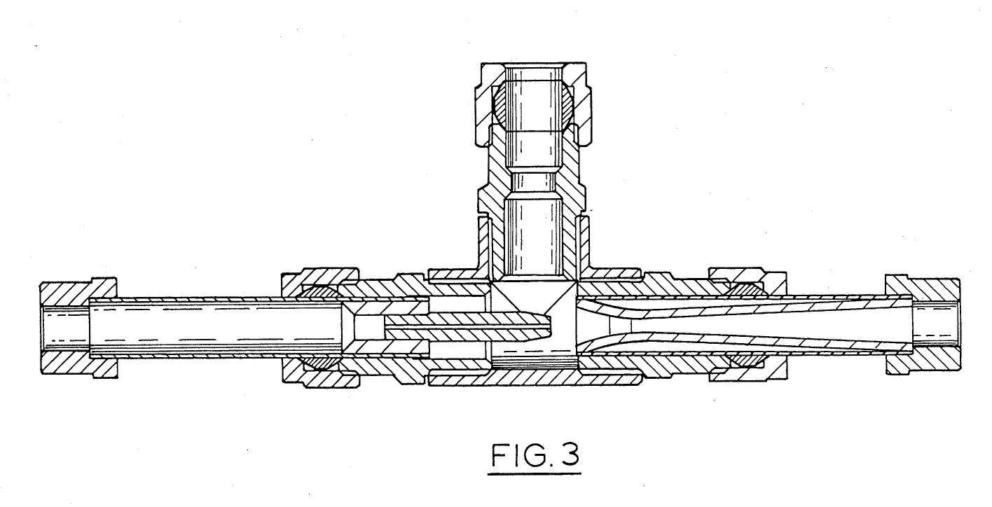

When fitted to a plumbing system, the device (1) may be installed at, or in close proximity to, a rainwater storage tank or it may be positioned closer to the actual source of intended use, for example, close to plumbing associated with a cistern for a toilet. The dimensions and positioning of the components for the device illustrated in FIG. 3 are sufficient for the present device to function when a toilet cistern is activated.

In use, upon activating the flow of reticulated water (for example, by flushing a toilet cistern), the flow of reticulated water RW into the body (2) is restricted by passing through the jet (13). As the pressure within the body (2) is consequently lowered at the exit of the jet (13), any rainwater TW is drawn from the rainwater tank through the hose or pipe (10) into the body (2) to be combined with the reticulated water RW in the body (2) before passing through the venturi (20).

By adjusting the dimensions and/or positioning of the jet (13) and/or venturi (20) and/or internal dimensions of one or more of the bodies (2,12,19), the pressure differential between the water as it enters the venturi (20) and as it exits the venturi (20) can be selected to provide an efficient performance for the device (1).

In this regard, although not wishing to be bound by theory, it is postulated that the success of the arrangement described in this application may be attributed to the maintenance of substantially narrow and confined or laminar flow of, for example, the reticulated water F as it passes through the venturi (20) (FIG. 2), particularly if the reticulated water flows through the venturi (20) at a pressure/velocity and position such that the water remains detached from the internal walls of the venturi (20) providing an annular zone for receiving incoming tank water. As the incoming tank water TW enters the body (2) and occupies the annulus around the stream F, the flow of the combined waters also remains substantially laminar or layered, thus reducing turbulence and maintaining a greater pressure differential between the back pressure and the pressure of the combined water flow entering the venturi.

The device described above with reference to the drawings offers a number of advantages which are discussed below. The device may be plumbed permanently into a reticulated water supply or be retrofitted reversibly to an existing, for example, the outlet tap of a rainwater tank. Other than the non-return valve, the device has no moving parts for its operational function, thus reducing maintenance costs. Further by appropriate selection of one or more component(s), the required pressure differential can usually be obtained for a particular situation. The device draws water from said one water reserve comprising the tank water in the tank automatically and without requiring any user intervention to actually draw the water. Thus provided that there is a supply of stored rain water the device will draw water from the tank. Yet further a plumbing arrangement including the device is silent in operation and thus very suitable for suburban environments including the plumbing arrangements of domestic dwellings in suburban environments.

It will be appreciated that the above described embodiment is only an exemplification of the various aspects of the present invention and that modifications and alterations can be made thereto without departing from the inventive concept as defined in the following claims.

I claim:

1. A device to combine fluid held in a first source at a first pressure with flowing fluid from a second source flowing at greater than said first pressure; said device including:
a hollow body adapted to be connected at one end to incoming said second source of fluid, its other end being adapted to subsequently distribute said incoming fluid for its required use after passing through said body; and
a pressure differential means within said hollow body;
wherein, said pressure differential means includes (a) a first restriction means through which said flowing fluid first passes, and (b) a second restriction means through which said flowing fluid issues from said first restriction means passes;
such that any fluid held in said first source is drawn into said hollow body to combine with said incoming fluid from said second source and to exit at said other end of said hollow body.

2. A device as claimed in claim 1, further including a communication conduit for connecting said hollow body to said first source of fluid for allowing water in said first source to pass into said hollow body.

3. A device as defined in claim 1 wherein, said first restriction means is adjustable positionally within said hollow body and wherein said first restriction means is removable from said hollow body.

4. A device as defined in claim 1 wherein, said second restriction means is adjustable positionally within said hollow body and wherein said second restriction means is removable from said hollow body.

5. A device as defined in claim 1 wherein, said first restriction means and said second restriction means are independently adjustable positionally within said hollow body.

6. A device as defined in claim 1 wherein, said first restriction means is a jet.

7. A device as defined in claim 1 wherein, said second restriction means is a venturi.

8. A device as defined in claim 2 wherein, said device includes a non-return valve mounted on said hollow body, said valve preventing fluid from said second source entering said first source.

9. A device as defined in claim 1 wherein the hollow body and the first restriction means therein provide for a substantially laminar flow of said flowing fluid as it passes through said second restriction means.

10. A device as defined in claim 1 wherein said fluid is a liquid.

11. A device as defined in claim 10 wherein said liquid is water.

12. A method to combine fluid held in a first source at a first pressure with flowing fluid from a second source flowing at greater than said first pressure, whereby a device as defined in claim 1 is fitted between an outlet of said second source of fluid and an outlet of said first source of fluid.

13. A device for combining water from a first source with a stream of water from a second source which is at a higher pressure than said one source, including:
a hollow body having a primary inlet for operative coupling to said second source of water and an outlet towards an opposed end thereof, and an intermediate inlet positioned intermediate said primary inlet and outlet for coupling to said first source of water,
a venturi positioned intermediate said intermediate inlet and said outlet, and
a flow restriction means positioned upstream of said venturi for restricting the flow of water issuing therefrom and passing into the venturi,
wherein water from said second source enters said body through said primary inlet and passes through said flow restriction means and draws water from said first source of water through said intermediate inlet and into the body where it combines with water from the second water source, passes through said venturi and is then discharged through the outlet as a combined stream of water.

14. A device according to claim 13, wherein the flow restriction means is a jet.

15. A device according to claim 14, wherein said jet is configured to produce a substantially laminar flow of water downstream of said jet.

16. A device according to claim 15, wherein the jet is positioned such that it is substantially longitudinally aligned with said intermediate inlet.

17. A device according to claim 14, wherein the hollow body comprises a support body component and a flow restrictor body component and a venturi body component, wherein the restrictor body component is releasably mounted on the support body component, and wherein the venturi body component is releasably mounted on the support body component.

18. A device according to claim 17, wherein the longitudinal position of the jet within the hollow body is adjustable to enable an operator to optimise operation of the device, and wherein the longitudinal position of the venturi within the body is adjustable to enable an operator to optimise operation of the device, wherein the longitudinal position of the jet within the hollow body can be adjusted by adjusting the longitudinal position of the restrictor body component relative to the support body component and the longitudinal position of the venturi within the hollow body can be adjusted by adjusting the longitudinal position of the venturi body component relative to the support body component.

19. A device according to claim 17, wherein the support body component is a T-body and wherein the primary inlet and the outlet are formed in one member of the T-body and the intermediate inlet is formed by the other member of the T-body, and wherein said T-body has a substantially circular cross sectional shape.

20. A method for combining water from one water source with a stream of water from another water source at a higher pressure than said one source, including:
providing a device including a hollow body having a primary inlet for operative coupling to said second source of water, and an outlet, and an intermediate inlet positioned intermediate said primary inlet and outlet for coupling to said first source of water, a venturi positioned intermediate said intermediate inlet and said outlet, and a flow restriction means positioned upstream of said venturi for restricting the flow of water passing there through, and
directing water from said second source through said primary inlet and through said flow restriction means,
whereby to draw water at a lower pressure from said first source of water at a lower pressure than said second source through said intermediate inlet where it combines with water from the second water source to form a combined water stream which is drawn through the venturi and then discharged from the outlet.
